(19) United States
(12) Patent Application Publication
(10) Pub. No.: US 2019/0270913 A1
(43) Pub. Date: Sep. 5, 2019

(54) POLISHING AGENT, POLISHING METHOD, AND LIQUID ADDITIVE FOR POLISHING

(71) Applicant: AGC Inc., Chiyoda-ku (JP)

(72) Inventor: Genki KOBAYASHI, Tokyo (JP)

(73) Assignee: AGC Inc., Chiyoda-ku (JP)

(21) Appl. No.: 16/288,137

(22) Filed: Feb. 28, 2019

(30) Foreign Application Priority Data
Mar. 2, 2018 (JP) 2018-037456

(51) Int. Cl. C09G 1/02; B24B 37/04; C09K 3/14

(52) U.S. Cl. CPC C09G 1/02; C09K 3/1463; B24B 37/044

(57) ABSTRACT

The present invention relates to a polishing agent including particles of a compound containing a cerium atom and an oxygen atom, an organic acid having a plurality of carboxylic acid groups or carboxylates, at least one member selected from the group consisting of a polyhydric alcohol and an addition polymerization product of a polyhydric alcohol with an alkylene oxide, and water, and having a pH of 4 to 9, a polishing method using the same, and a liquid additive for polishing.

### TECHNICAL FIELD

The present invention relates to a polishing agent, a polishing method, and a liquid additive for polishing. More specifically, the present invention relates to a polishing agent for chemical mechanical polishing in the manufacture of a semiconductor integrated circuit, a polishing method using the polishing agent, and a liquid additive for polishing for preparing a polishing agent.

### BACKGROUND ART

In recent years, with a trend toward high integration and high functionality of a semiconductor integrated circuit, development of a microfabrication technology for realizing miniaturization and density growth of a semiconductor element is advancing. In the manufacture of a semiconductor integrated circuit device (hereinafter, sometimes referred to as “semiconductor device”), an interlayer insulating film, an embedded wiring, etc. have been conventionally flattened using Chemical Mechanical Polishing (hereinafter, referred to as “CMP”) so as to prevent such a problem that unevenness (difference in level) of a layer surface exceeds the depth of focus of lithography and sufficient resolution is not obtained. Importance of high flattening by CMP is increasing as the demand for high definition or miniaturization of an element becomes severer.

Furthermore, in the manufacture of a semiconductor device, in order to proceed with higher miniaturization of a semiconductor element, an isolation method by shallow trench having a small element isolation width (Shallow Trench Isolation; hereinafter, referred to as “STI”) has been introduced.

STI is a technique of forming a trench (groove) on a silicon substrate, embedding an insulating film in the trench, and thereby forming an electrically insulated element region. In STI, first, as illustrated in FIG. 1A, an element region of a silicon substrate 1 is masked with a silicon nitride film 2, etc., a trench 3 is then formed on the silicon substrate 1, and an insulating layer such as silicon dioxide film 4 is deposited to fill the trench 3. Subsequently, the silicon dioxide film 4 on the silicon nitride film 2, defining a convex part, is polished and removed by CMP while leaving the silicon dioxide film 4 in the trench 3 defining a concave part. Consequently, an element isolation structure in which the silicon dioxide film 4 is embedded in the trench 3 as illustrated in FIG. 1B is obtained.

In the CMP technology including polishing of a silicon dioxide film in such STI, a high polishing rate for the silicon dioxide film is required from a cost perspective.

To meet this requirement, a method for improving the polishing characteristics of a polishing agent in conformity with the required characteristics above has been proposed. As the polishing agent for a hard disk substrate or a semiconductor substrate, Patent Document 1 discloses a polishing agent containing a cerium oxide particle, etc. as the abrasive and containing an organic acid with a multidentate ligand, and Patent Document 2 discloses a polishing agent containing cerium oxide, etc. as the abrasive and containing a polyhydric alcohol.

However, the polishing agents disclosed in Patent Documents 1 and 2 are disadvantageous in that the polishing rate is insufficient and among others, the polishing rate for a silicon dioxide film is further decreased in the polishing using a soft pad.

### BACKGROUND ART DOCUMENTS

### Patent Documents

[Patent Document 1] JP-A-2000-160142

[Patent Document 2] JP-A-2006-278773

### SUMMARY OF THE INVENTION

### Problems that the Invention is to Solve

The present invention has been made to solve the above-described problems and has an object to provide a polishing agent, a polishing method, and a liquid additive for polishing, ensuring that a sufficiently high polishing rate for a silicon oxide film such as silicon dioxide film can be achieved, for example, in CMP, particularly CMP of a surface to be polished including a silicon oxide surface in STI.

### Means for Solving the Problems

A polishing agent of the present invention includes:

particles of a compound containing a cerium atom and an oxygen atom;

an organic acid having a plurality of carboxylic acid groups or carboxylates;

at least one member selected from the group consisting of a polyhydric alcohol and an addition polymerization product of a polyhydric alcohol with an alkylene oxide; and

water, and

the polishing agent has a pH of 4 to 9.

In the polishing agent of the invention, it is preferred that the organic acid having a plurality of carboxylic acid groups or carboxylates is at least one member selected from the group consisting of a polymer of an unsaturated carboxylic acid, a copolymer of an unsaturated carboxylic acid and a monomer containing no carboxylic acid group, a partially esterified product of the polymer or the copolymer, and salts thereof. The particle of a compound containing a cerium atom and an oxygen atom is preferably a cerium oxide particle. In the polishing agent of the invention, it is preferred that the organic acid having a plurality of carboxylic acid groups or carboxylates is at least one member selected from the group consisting of a polymer of an acrylic acid, a copolymer of an acrylic acid and a monomer other than an acrylic acid, a partially esterified product of the polymer or copolymer, and salts thereof. In the polishing agent of the invention, it is preferred that the organic acid having a plurality of carboxylic acid groups or carboxylates is at least one member selected from the group consisting of a polymer containing at least one member selected from the group consisting of maleic acid and fumaric acid, a copolymer of at least one member selected from the group consisting of maleic acid and fumaric acid and a monomer which is neither maleic acid nor fumaric acid, a partially esterified product of the polymer or the copolymer, and salts thereof.

It is preferred that the polyhydric alcohol contains polyglycerin, and the addition polymerization product of a polyhydric alcohol with an alkylene oxide contains a polyoxyalkylene polyglyceryl ether, provided that the alkylene is at least one member selected from the group consisting of ethylene and propylene.

In the polishing agent of the invention, it is preferred that the content ratio of the organic acid having a plurality of carboxylic acid groups or carboxylates is from 0.001 to 2.0 mass % relative to a total mass of the polishing agent. It is preferred that the content ratio of the at least one member selected from the group consisting of the polyhydric alcohol and the addition polymerization product of a polyhydric alcohol with an alkylene oxide is from 0.001 to 2.0 mass % relative to the total mass of the polishing agent. In the polishing agent of the invention, it is preferred that an average secondary particle diameter of particles of the compound containing a cerium atom and an oxygen atom is from 10 nm to 500 nm, and it is more preferred that the average secondary particle diameter of the particle of the compound containing a cerium atom and an oxygen atom is from 10 nm to 170 nm. In the polishing agent of the invention, it is preferred that the content ratio of the particle of the compound containing a cerium atom and an oxygen atom is from 0.01 to 10.0 mass % relative to the total mass of the polishing agent.

A polishing method of the invention includes bringing a polishing pad into contact with a surface to be polished while supplying a polishing agent to perform polishing by relative movement thereof, in which the surface to be polished including a surface composed of silicon oxide of a semiconductor substrate is polished with the polishing agent according to any one of claims 1 to 10 as the polishing agent.

A liquid additive for polishing of the present invention, which is a liquid additive for preparing a polishing agent by mixing with a dispersion liquid of particles of a compound containing a cerium atom and an oxygen atom, includes:

an organic acid having a plurality of carboxylic acid groups or carboxylates;

at least one member selected from the group consisting of a polyhydric alcohol and an addition polymerization product of a polyhydric alcohol with an alkylene oxide; and

water, and

the polishing agent has a pH of 4 to 9.

In the liquid additive for polishing of the invention, it is preferred that the organic acid having a plurality of carboxylic acid groups or carboxylates is at least one member selected from the group consisting of a polymer of an unsaturated carboxylic acid, a copolymer of an unsaturated carboxylic acid and a monomer containing no carboxylic acid group, a partially esterified product of the polymer or the copolymer, and salts thereof.

The term “surface to be polished” as used in the present invention is a surface to be polished of a polishing target and means, for example, the surface. In the present description, an intermediate step surface appearing on a semiconductor substrate in the process of manufacturing a semiconductor device is also encompassed by the “surface to be polished”.

Furthermore, the “silicon oxide” as used in the present invention is specifically silicon dioxide but is not limited thereto and encompasses silicon oxides other than silicon dioxide.

The “unit” in a polymer or a copolymer means a moiety derived from a monomer, which is formed by polymerization of the monomer.

In the present description, the numerical value range expressed using “to” includes the upper and lower limits.

### Advantages of the Invention

According to the polishing agent and the polishing method of the present invention, a sufficiently high polishing rate for a silicon oxide film can be achieved, for example, in CMP, particularly CMP of a surface to be polished including silicon oxide surface in STI.

### BRIEF DESCRIPTION OF THE DRAWINGS

FIGS. 1A and 1B are cross-sectional diagrams of a semiconductor substrate, illustrating a polishing method by CMP in STI.

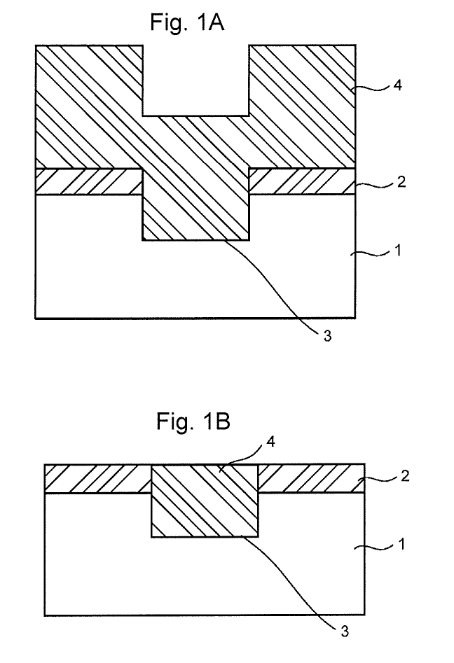

FIG. 2 is a diagram illustrating one example of a polishing apparatus usable in the polishing method of the present invention.

### MODE FOR CARRYING OUT THE INVENTION

An embodiment of the present invention is described below. However, the present invention is not limited to the following embodiment, and other embodiments can be included in the scope of the present invention so long as they conform to the gist of the present invention.

### <Polishing Agent>

The polishing agent of the present invention includes particles of a compound containing a cerium atom and an oxygen atom, an organic acid having a plurality of carboxylic acid groups or carboxylates, at least one member selected from the group consisting of a polyhydric alcohol and an addition polymerization product of a polyhydric alcohol with an alkylene oxide, and water, and has a pH of 4 to 9. Hereinafter, the particle of a compound containing a cerium atom and an oxygen atom is referred to as “cerium compound particle”. Hereinafter, the at least one member selected from the group consisting of a polyhydric alcohol and an addition polymerization product of a polyhydric alcohol with an alkylene oxide is sometimes referred to as a nonionic compound (P).

When the polishing agent of the present invention is used, for example, for CMP of a surface to be polished including a silicon oxide film (e.g., a silicon dioxide film) in STI, polishing having a high polishing rate for the silicon oxide film can be realized.

The mechanism by which the polishing agent of the present invention exhibits such excellent polishing characteristics is not clear, but this is considered to be achieved due to containing both an organic acid having a plurality of carboxylic acid groups or carboxylates and a nonionic compound (P) having a specific molecular structure. More specifically, it is considered that the organic acid having a plurality of carboxylic acid groups or carboxylates, contained in the polishing agent, is electrostatically adsorbed to the cerium compound particle surface and the surface to be polished including a silicon oxide film, in the presence of the nonionic compound (P) having a specific molecular structure, via a terminal group of the organic acid molecule in the pH region of 4 to 9. Then the state of the cerium compound particle surface and the surface to be polished including a silicon oxide film is thereby optimized. As a result, a high polishing rate for a silicon oxide film can be obtained without impairing the dispersibility of the cerium compound particle.

Each component contained in the polishing agent of the present invention and the pH are describe below.

### (Cerium Compound Particle)

The cerium compound particle contained in the polishing agent of the present invention has a function as an abrasive grain. The cerium compound particle includes particles of a cerium compound such as cerium oxide and cerium hydroxide. The cerium compound particle is preferably a cerium oxide particle because of its high polishing rate for a silicon oxide film.

In the case of using the cerium oxide particle as the cerium compound particle in the polishing agent of the present invention, the cerium oxide particle contained in the polishing agent is not particularly limited, but a cerium oxide particle produced by the method described, for example, in JP-A-11-12561 or JP-A-2001-35818 can be used. More specifically, a cerium oxide particle obtained by adding an alkali to an aqueous cerium(1V) nitrate ammonium solution to prepare a cerium hydroxide gel and subjecting the gel to filtration, washing and baking, or a cerium oxide particle obtained by subjecting high-purity cerium carbonate to pulverization and baking and further to pulverization and classification, can be used. In addition, a cerium oxide particle obtained by chemically oxidizing a cerium (III) salt in liquid as described in JP-T-2010-505735 can also be used.

The average particle diameter of the cerium compound particle is preferably from 10 nm to 500 nm, more preferably from 10 nm to 170 nm. If the average particle diameter exceeds 500 nm, a polishing flaw such as scratch may be generated on the surface to be polished. On the other hand, if the average particle diameter is less than 10 nm, not only the polishing rate may decrease but also since the percentage of the surface area per unit volume is large, the cerium compound particle is susceptible to the influence of surface state and is likely to undergo aggregation depending on the conditions such as pH and additive concentration.

The cerium compound particle like the cerium oxide particle exists, in the polishing agent, as an aggregate particle (secondary particle) resulting from aggregation of primary particles and therefore, the preferable particle diameter of the cerium compound particle is expressed by the average secondary particle diameter. More specifically, the cerium compound particle preferably has an average secondary particle diameter of 10 nm to 500 nm, more preferably from 10 nm to 170 nm. The average secondary particle diameter is measured using a dispersion liquid dispersed in a dispersion medium such as pure water and using particles size distribution meter such as laser diffraction-scattering system.

The content ratio (concentration) of the cerium compound particle is preferably from 0.01 to 10 mass % relative to the total mass of the polishing agent. When the content ratio of the cerium compound particle is from 0.01 to 10 mass %, a sufficiently high polishing rate for a silicon oxide film is obtained. In addition, when the content ratio of the cerium compound particle is within this range, the viscosity of the polishing agent is not too high, and handling of the polishing agent is good. The content ratio (concentration) of the cerium compound particle is more preferably from 0.025 to 3.0 mass %, still more preferably from 0.025 to 1.0 mass %.

A cerium compound particle in a state of being already dispersed in a medium (hereinafter, referred to as “cerium compound particle dispersion liquid”) may also be used. As the medium, water may be preferably used.

### (Water)

In the polishing agent of the present invention, water is contained as a medium for dispersing the cerium compound particle therein and at the same time, as a medium for dissolving the organic acid having a plurality of carboxylic acid and the nonionic compound (P), which are described later. The kind of water is not particularly limited, but in consideration of the effect on the organic acid having a plurality of carboxylic acid and the nonionic compound (P), prevention of contamination of impurities, and effect on pH, etc., it is preferable to use, for example, pure water, ultrapure water, or ion-exchanged water.

### (Organic Acid Having a Plurality of Carboxylic Acid Groups or Carboxylates)

The carboxylic acid group in the organic acid having a plurality of carboxylic acid groups or carboxylates, used in the polishing agent of the embodiment, has the same meaning as the carboxyl group. The carboxylates indicate a group in which a carboxyl group is converted to a salt form by neutralization. In the following description, unless otherwise indicated, the “organic acid” means an organic acid having a plurality of carboxylic acid groups or carboxylates. In the polishing agent of the embodiment, the organic acid is used together with water, and the carboxylic acid group or carboxylic acid base is used in an ionically dissociated state. The plurality of carboxylic acid groups or carboxylates possessed by the organic acid may be all a carboxylic acid group, may be all a carboxylic acid base, or may be partially a carboxylic acid group, with the remaining being a carboxylic acid base.

The number of carboxylic acid groups or carboxylates possessed by the organic acid is 2 or more per molecule. When the organic acid has two or more carboxylic acid groups or carboxylates per molecule, in combination with the action of the nonionic compound (P), excellent polishing characteristics are obtained in the polishing agent as described above.

The organic acid is preferably at least one member selected from the group consisting of a polymer of an unsaturated carboxylic acid, a copolymer of an unsaturated carboxylic acid and a monomer containing no carboxylic acid group, a partially esterified product of the polymer or copolymer, and salts thereof.

The unsaturated carboxylic acid includes an unsaturated monocarboxylic acid, an unsaturated dicarboxylic acid, etc. The unsaturated monocarboxylic acid specifically includes an acrylic acid, a methacrylic acid, a crotonic acid, etc. Among these, an acrylic acid is preferred.

The unsaturated dicarboxylic acid specifically includes maleic acid, fumaric acid, itaconic acid, citraconic acid, mesaconic acid, 2-allylmalonic acid, isopropylidenesuccinic acid, etc. Among these, at least one member selected from the group consisting of maleic acid, fumaric acid and itaconic acid is preferred, and maleic acid and fumaric acid are more preferred from the viewpoint of polymerizability.

The polymer of an unsaturated carboxylic acid may be a homopolymer obtained by polymerizing one kind of unsaturated carboxylic acid or may be a copolymer of a combination of two or more kinds. The polymer specifically includes polyacrylic acid, polymaleic acid, polyfumaric acid, polymethacrylic acid, polyitaconic acid, polycrotonic acid, acrylic acid/maleic acid copolymer, acrylic acid/methacrylic acid copolymer, acrylic acid/fumaric acid copolymer, maleic acid/fumaric acid copolymer, etc.

The organic acid may be a copolymer of an unsaturated carboxylic acid and a monomer containing no carboxylic acid group. The monomer containing no carboxylic acid group includes a sulfonic acid-based monomer, a vinyl ester-based monomer, an aromatic vinyl-based monomer, an α-olefin, a vinyl ether-based monomer, an allyl compound, an N-alkyl-substituted (meth)acrylamide, and a nitrile-based monomer. Here, the (meth)acrylamide is a generic term of acrylamide and methacrylamide, and the same interpretation applies to other compounds.

The sulfonic acid-based monomer includes 2-acrylamide-2-methylpropanesulfonic acid, styrenesulfonic acid, allylsulfonic acid, methacrylsulfonic acid; the vinyl ester-based monomer includes, for example, vinyl acetate and vinyl propionate; the aromatic vinyl-based monomer includes styrene, methylstyrene, vinylnaphthalene; the α-olefin includes isobutylene, diisobutylene; the vinyl ether-based monomer includes vinyl methyl ether, vinyl ethyl ether, vinyl isobutyl ether; the allyl compound includes, for example, allyl alcohol, allyl ethyl ether, allyl butyl ether, allyl glycidyl ether, and an alkylene oxide (hereinafter, referred to as AO) adduct (the AO adduct includes an ethylene oxide (hereinafter, referred to as EO) adduct and a propylene oxide (hereinafter, referred to as PO) adduct) of allyl alcohol; the N-alkyl-substituted (meth)acrylamide includes, for example, N-methyl(meth)acrylamide, N-ethyl(meth)acrylamide; and the nitrile-based monomer includes, for example, (meth)acrylonitrile.

In addition, an unsaturated carboxylic acid ester such as (meth)acrylic acid ester-based monomer may also be used as the monomer containing no carboxylic acid group. When an unsaturated carboxylic acid and an unsaturated carboxylic acid ester are thus copolymerized, a partially esterified product of a polymer of an unsaturated carboxylic acid is obtained. In addition, the partially esterified product of a polymer of an unsaturated carboxylic acid may be obtained by partially esterifying a polymer of an unsaturated carboxylic acid by a known method. Similarly, when an unsaturated carboxylic acid, an unsaturated carboxylic acid ester and a monomer other than these are copolymerized, a partially esterified product of a copolymer of an unsaturated carboxylic acid and a monomer containing no carboxylic acid group is obtained.

The unsaturated carboxylic acid ester is a compound resulting from conversion of a carboxylic acid group (—C(═O)—OH) of an unsaturated carboxylic acid to —C(═O)—O—R¹ (wherein R¹ is a monovalent substituent). R¹ is preferably a substituted or unsubstituted saturated hydrocarbon group having a carbon number of 1 to 50, which may have an oxygen atom between carbon-carbon atoms. R¹ is more preferably a substituted or unsubstituted saturated hydrocarbon group having a carbon number of 2 to 30, still more preferably a carbon number of 5 to 20, which may have an oxygen atom between carbon-carbon atoms. The saturated hydrocarbon group may be linear, branched or cyclic and may be a linear or branched group containing a cyclic structure. Furthermore, the substituent of the substituted saturated hydrocarbon group includes hydroxyl group, epoxy group, and amino group.

R¹ specifically includes methyl group, ethyl group, propyl group, n-butyl group, 2-ethylhexyl group, lauryl group, 2-hydroxylethyl group, polyethylene glycol group, methoxy-polyethylene glycol group, glycidyl group, dimethylaminoethyl group and diethylaminoethyl group. The unsaturated carboxylic acid ester is preferably a (meth)acrylic acid ester.

The organic acid described above is an organic acid having a plurality of carboxylic acid groups. The organic acid having carboxylates is an organic acid in which at least a part of carboxylic acid groups of the organic acid above is converted into a salt. The counter ion of the salt of the carboxylic acid group includes, for example, an alkali metal salt such as sodium and potassium, an alkaline earth metal salt such as magnesium and calcium, an ammonium salt, an amine salt, and an organic amine salt. In view of solubility in water used for the polishing agent, an alkali metal salt such as sodium and potassium, and an ammonium salt are preferred, and an ammonium salt is more preferred.

The polymer or copolymer serving as the organic acid is obtained by polymerizing the above-described monomers individually or in an appropriate combination by a known method. The weight average molecular weight of the organic acid is preferably from 500 to 1,000,000, more preferably from 1,000 to 20,000, still more preferably from 2,000 to 10,000. When the weight average molecular weight of the organic acid is 500 or more, a state where the organic acid is adsorbed to the cerium oxide particle surface and the surface to be polished including a silicon nitride film, can be stably ensured. When the weight average molecular weight of the organic acid is 1,000,000 or less, the handleability, etc. are improved. In addition, unless otherwise indicated, the weight average molecular weight as used in the present description is a weight average molecular weight measured by gel permeation chromatograph (GPC).

The proportion of the unit of the unsaturated carboxylic acid in the organic acid is preferably from 40 to 100 mol %, more preferably from 50 to 100 mol %, still more preferably from 60 to 100 mol %, and it is especially preferred that the unit is substantially only the unit of the unsaturated carboxylic acid. Here, the “substantially only the unit of the unsaturated carboxylic acid” means that the proportion of the unit of the unsaturated carboxylic acid in all units is 95 mol % or more, preferably 98 mol % or more.

The organic acid used in the present invention is preferably an organic acid substantially composed of the unit of the unsaturated carboxylic acid alone, more preferably an organic acid containing an acrylic acid as an essential constituent unit, still more preferably a polyacrylic acid substantially composed of the unit of an acrylic acid alone.

As the organic acid, one kind may be used alone, or two or more kinds may be used in combination. The content ratio (concentration) of the organic acid in the polishing agent is preferably from 0.001 to 2.0 mass % relative to the total mass of the polishing agent. When the content ratio of the organic acid is in the range above, the effect of increasing the polishing rate of a silicon oxide film and enhancing the selection ratio is sufficiently obtained, and the dispersion stability of the cerium compound particle as the abrasive grain is improved. The content ratio of the organic acid is more preferably from 0.01 to 1.5 mass % relative to the total mass of the polishing agent.

### (Nonionic Compound (P))

The nonionic compound (P) contained in the polishing agent of the present invention is composed of at least one member selected from the group consisting of a polyhydric alcohol and an addition polymerization product of a polyhydric alcohol with an alkylene oxide. The nonionic compound (P) may be composed of only one of these or may be composed of two or more thereof.

The polyhydric alcohol is preferably an aliphatic polyhydric alcohol, and examples thereof include ethylene glycol, propylene glycol, glycerin, pentaerythritol, xylitol, sorbitol, and their polymerization products. The polyhydric alcohol is preferably a polyglycerin obtained by polymerization of two or more glycerins.

The polyhydric alcohol in the addition polymerization product of a polyhydric alcohol with an alkylene oxide may be a monomolecular polyhydric alcohol such as ethylene glycol, propylene glycol, glycerin, pentaerythritol, xylitol and sorbitol, and may also be a polymerization product thereof. The polyhydric alcohol is preferably a polyglycerin. The degree of polymerization of the polyglycerin is not particularly limited but is preferably from 2 to 10, more preferably 2. The alkylene oxide that is addition-polymerized to a polyhydric alcohol includes ethylene oxide, propylene oxide, butylene oxide, etc., with ethylene oxide and propylene oxide being preferred. The alkylene oxide used at the time of addition polymerization to a polyhydric alcohol may be one kind or may be two or more kinds.

The addition polymerization product of a polyhydric alcohol with an alkylene oxide is preferably a polyoxyalkylene polyglyceryl ether (provided that the alkylene is at least one member selected from the group consisting of ethylene and propylene), more preferably a polyoxyalkylene diglyceryl ether (provided that the alkylene is at least one member selected from the group consisting of ethylene and propylene). The plurality of oxyalkylene groups possessed by the polyoxyalkylene polyglyceryl ether and polyoxyalkylene diglyceryl ether may be composed of only either one of an oxyethylene group and an oxypropylene group or may be composed of both.

As the polyoxyalkylene polyglyceryl ether, a polyoxyethylene polyglyceryl ether and a polyoxypropylene polyglyceryl ether are preferred. The polyoxyethylene polyglyceryl ether and the polyoxypropylene polyglyceryl ether are preferably a polyoxyethylene diglyceryl ether and a polyoxypropylene diglyceryl ether, respectively

The weight average molecular weight of the nonionic compound (P) is preferably from 300 to 100,000, more preferably from 300 to 10,000. When the weight average molecular weight is 300 or more, a state in which the organic acid having a plurality of carboxylic acid groups or carboxylates is adsorbed to the cerium compound particle surface and the surface to be polished including a silicon oxide film, can be stably ensured. When the weight average molecular weight is 100,000 or less, this is advantageous in view of handleability.

The polyglycerin as a preferred embodiment of the polyhydric alcohol in the nonionic compound (P) is preferably a polymer represented by the following formula (1) (hereinafter, referred to as polymer (1)). The polyoxyalkylene diglyceryl ether (provided that the alkylene is at least one member selected from the group consisting of ethylene and propylene) as a preferred embodiment of the addition polymerization product of a polyhydric alcohol with an alkylene oxide is preferably a polymer represented by the following formula (2) (hereinafter, referred to as polymer (2)).

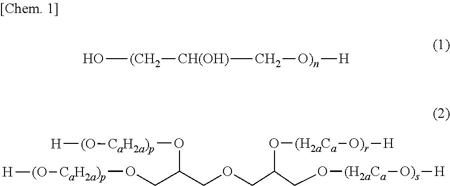

wherein, in formula (1), n≥4. In formula (2), a is independently 2 or 3, and p+q+r+s≥4. When p is 2 or more, p pieces of CₐH₂ₐO may be composed of only either one of C₂H₄O and C₃H₆O or may be composed of both. In the case of being composed of both of C₂H₄O and C₃H₆O, these units may be bonded in any of alternate, random and block forms. The same holds true for q, r and s.

The nonionic compound (P) may be composed of one member selected from the group consisting of polymers (1) and polymers (2) or may be composed of two or more thereof. In addition, among polymers (2), the polyoxyethylene diglyceryl ether is preferably a polymer represented by the following formula (21) (hereinafter, referred to as polymer (21)). The polyoxypropylene polyglyceryl ether is preferably a polymer represented by the following formula (22) (hereinafter, referred to as polymer (22)).

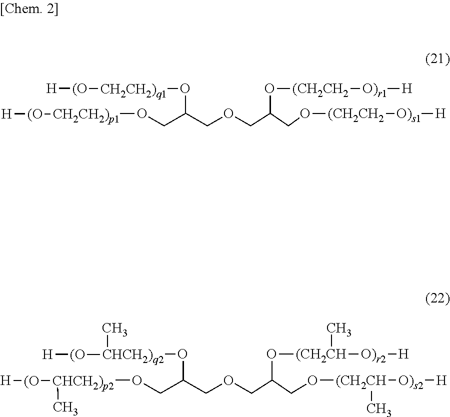

(wherein in formula (21), p1+q1+r1+s1≥4, and in formula (22), p2+q2+r2+s2≥4).

Preferred embodiments of the polymer (1), the polymer (21) and the polymer (22) are described below by an example, but the nonionic compound (P) is not limited thereto.

The polymer (1) is a polyglycerin in which the polymerization degree represented by n is 4 or more. The polymer (1) is preferably a polyglycerin having a weight average molecular weight of 300 or more. When the weight average molecular weight is 300 or more, a state where the organic acid having a plurality of carboxylic acid groups or carboxylates is adsorbed to the cerium compound particle surface and the surface to be polished including a silicon oxide film, can be stably ensured. The upper limit of the weight average molecular weight of the polymer (1) is preferably about 100,000 from the viewpoint of handleability, etc. The weight average molecular weight of the polymer (1) is more preferably from 300 to 10,000.

Incidentally, n in formula (1) represents an average value among molecules. n is 4 or more on average, and the upper limit of n is a numerical value giving the weight average molecular weight of the upper limit above.

The polymer (21) is a polyoxyethylene diglyceryl ether obtained by addition-polymerizing ethylene oxide to diglycerin. The polymer (21) preferably has a weight average molecular weight of 300 or more. When the weight average molecular weight is 300 or more, a state where the organic acid having a plurality of carboxylic acid groups or carboxylates is adsorbed to the cerium compound particle surface and the surface to be polished including a silicon oxide film, can be stably ensured. The upper limit of the weight average molecular weight of the polymer (21) is preferably about 100,000 from the viewpoint of handleability, etc. The weight average molecular weight of the polymer (21) is more preferably from 300 to 10,000.

In formula (21), p1+q1+r1+s1 which is the total of repeating units of 4 oxyethylene chains is 4 or more, and as long as the total is 4 or more, individual numerical values of p1, q1, r1 and s1 are not limited. Here, p1+q1+r1+s1≥4 indicates that p1+q1+r1+s1 is 4 or more as an average value among molecules. In addition, the upper limit of p1+q1+r1+s1 is a numerical value giving the weight average molecular weight of the upper limit above.

The polymer (22) is a polyoxypropylene diglyceryl ether obtained by addition-polymerizing propylene oxide to diglycerin. The polymer (22) preferably has a weight average molecular weight of 400 or more. When the weight average molecular weight is 400 or more, a state where the organic acid having a plurality of carboxylic acid groups or carboxylates is adsorbed to the cerium compound particle surface and the surface to be polished including a silicon oxide film, can be stably ensured. The upper limit of the weight average molecular weight of the polymer (22) is preferably about 100,000 from the viewpoint of handleability, etc. The weight average molecular weight of the polymer (22) is more preferably from 400 to 10,000.

In formula (22), p2+q2+r2+s2 which is the total of repeating units of 4 oxypropylene chains is 4 or more, and as long as the total is 4 or more, individual numerical values of p2, q2, r2 and s2 are not limited. Here, p2+q2+r2+s24 indicates that p2+q2+r2+s2 is 4 or more as an average value among molecules. In addition, the upper limit of p2+q2+r2+s2 is a numerical value giving the weight average molecular weight of the upper limit above.

The nonionic compound (P) is preferably composed of at least one member selected from the group consisting of polyglycerins and polyoxyalkylene polyglyceryl ethers (provided that the alkylene is at least one member selected from the group consisting of ethylene and propylene), for example, a polyoxyethylene polyglyceryl ether and a polyoxypropylene polyglyceryl ether, and is more preferably composed of at least one member selected from the group consisting of the polymer (1), the polymer (21), and the polymer (22).

The content ratio (concentration) of the nonionic compound (P) is preferably from 0.001 to 2.0 mass % relative to the total mass of the polishing agent. When the content of the nonionic compound (P) is from 0.001 to 2.0 mass %, not only a sufficiently high polishing rate for a silicon oxide film but also a high selection ratio are obtained and in turn, the flatness in a pattern is improved. The content ratio of the nonionic compound (P) is more preferably from 0.005 to 1.0 mass %, still more preferably from 0.01 to 0.80 mass %, relative to the total mass of the polishing agent.

(pH)

The pH of the polishing agent of the present invention is from 4 to 9. When the pH of the polishing agent is from 4 to 9, the effect of increasing the polishing rate of a silicon oxide film is sufficiently obtained, and the dispersion stability of the cerium compound particle as an abrasive grain is also improved. The pH of the polishing agent is more preferably from 5 to 8, still more preferably from 6 to 8.

In order to adjust the pH to a predetermined value of 4 to 9, the polishing agent of the present invention may contain, as a pH adjusting agent, various inorganic acids, an organic acid (hereinafter, referred to “other organic acid”) other than the organic acid having a plurality of carboxylic acid groups or carboxylates, or a salt or basic compound thereof

The inorganic acid or inorganic acid salt is not particularly limited, but, for example, a nitric acid, a sulfuric acid, a hydrochloric acid, a phosphoric acid, and ammonium salts or potassium salts thereof can be used. The other organic acid or the salt of the other organic acid is not particularly limited, but, for example, hydroxy acids such as lactic acid, citric acid, malic acid, tartaric acid and glyceric acid can be used. The basic compound is preferably water-soluble but is not particularly limited. As the basic compound, for example, ammonia, potassium hydroxide, a quaternary ammonium hydroxide such as tetramethylammonium hydroxide (hereinafter, referred to as TMAH) and tetraethylammonium hydroxide, and an organic amine such as monoethanolamine and ethylenediamine, can be used.

In addition to the components described above, the polishing agent of the present invention may contain a dispersant (or an aggregation inhibitor). The dispersant is contained so as to stably disperse the cerium compound particle, such as cerium oxide particle, in a dispersion medium such as pure water. The dispersant includes anionic, cationic and amphoteric surfactants, and anionic, cationic and amphoteric polymer compounds, and one kind or two or more kinds thereof may be incorporated. In addition, as long as the effects of the present invention are not impaired, the polishing agent of the present invention may contain a nonionic polymer other than the nonionic compound (P). Furthermore, the polishing agent of the present invention may appropriately contain a lubricant, a tackifier or viscosity adjuster, an antiseptic, etc., if desired.

For the convenience of storage or transportation of the polishing agent of the present invention, a cerium compound particle dispersion liquid (hereinafter, sometimes referred to as “dispersion liquid a”) and an aqueous solution prepared by dissolving the organic acid having a plurality of carboxylic acid groups or carboxylates and the nonionic compound (P) in water (hereinafter, sometimes referred to as “aqueous solution β”) may be separately prepared as two liquids preferably such that the pH is from 4 to 9 in each liquid, and these liquids may be mixed when used. In addition, this aqueous solution β is the below-described liquid additive for polishing.

### <Liquid Additive for Polishing>

The liquid additive for polishing of the present invention is a liquid additive for preparing a polishing agent by mixing it with the cerium compound particle dispersion liquid (the dispersion liquid a above) and contains an organic acid having a plurality of carboxylic acid groups or carboxylates, at least one member (the nonionic compound (P)) selected from the group consisting of a polyhydric alcohol and an addition polymerization product of a polyhydric alcohol with an alkylene oxide, and water, and has a pH of 4 to 9. In the preparation of a polishing agent, when the liquid additive for polishing is used, the convenience of storage or transportation of the polishing agent can be enhanced.

Respective components contained in the liquid additive for polishing of the present invention, i.e., an organic acid having a plurality of carboxylic acid groups or carboxylates, a nonionic compound (P) and water, and the pH of the liquid are the same as those described for respective components contained in the polishing agent and the pH of the liquid.

In the liquid additive for polishing of the present invention, the content ratio (concentration) of the organic acid having a plurality of carboxylic acid groups or carboxylates is not particularly limited but from the viewpoint of ease of handling of the liquid additive or ease of mixing with the cerium compound particle dispersion liquid, is preferably from 0.001 to 10 mass % relative to the total amount of the liquid additive.

In the liquid additive for polishing of the present invention, the content ratio (concentration) of the nonionic compound (P) is not particularly limited but from the view point of ease of handling of the liquid additive or ease of mixing with the cerium compound particle dispersion liquid, is preferably from 0.001 to 10 mass % relative to the total amount of the liquid additive.

The pH of the additive liquid for polishing of the present invention is from 4 to 9. When the pH of the additive liquid for polishing is from 4 to 9, by mixing the dispersion liquid of the cerium compound together, the effect of, for example, increasing the polishing rate of a silicon oxide film and enhancing the flatness in the polishing of a pattern substrate is sufficiently obtained, and a polishing agent improved also in the dispersion stability of the cerium compound particle as the abrasive grain is obtained. The pH of the additive liquid for polishing is more preferably from 5 to 8, still more preferably from 6 to 8.

In the cerium compound particle dispersion liquid to be mixed with such a liquid additive for polishing, the content ratio (concentration) of the cerium compound particle in liquid is preferably from 0.01 to 40 mass % from the view point of, for example, dispersibility of the cerium compound particle and ease of handling of the dispersion liquid, and is more preferably from 0.01 to 20 mass %, still more preferably from 0.01 to 10 mass %.

By mixing the liquid additive for polishing of the present invention with the cerium compound particle dispersion liquid, the above-described polishing agent improved in the polishing rate while maintaining sufficiently high flatness for a silicon oxide film can be realized. Here, at the time of mixing the liquid additive for polishing and the cerium compound particle dispersion liquid, the liquid additive for polishing may be added to the cerium compound particle dispersion liquid and mixed, or the cerium compound particle dispersion liquid may be added to the liquid additive for polishing and mixed.

The mixing ratio between the liquid additive for polishing and the cerium compound particle dispersion liquid is not particularly limited and is preferably a mixing ratio giving a polishing agent after mixing in which the content ratios (concentrations) of the organic acid having a plurality of carboxylic acid groups or carboxylates and the nonionic compound (P) are from 0.001 to 2.0 mass % and from 0.001 to 2.0 mass %, respectively, relative to the total mass of the polishing agent. From a view point of ease of mixing of the liquid additive for polishing and the cerium compound particle dispersion liquid, these are preferably mixed in a mass ratio of liquid additive for polishing:cerium compound particle dispersion liquid=from 130:1 to 1:130.

In addition, in the case where the cerium compound particle dispersion liquid (dispersion liquid α) and the liquid additive for polishing (aqueous solution β) of the present invention are separately prepared as two liquids and mixed to prepare the polishing agent, the liquids may be prepared such that the content ratio (concentration) of the cerium compound particle in the dispersion liquid a and each concentration of the organic acid having a plurality of carboxylic acid groups or carboxylates and the nonionic compound (P) in the liquid additive for polishing (aqueous solution β), respectively, are set from 2 to 100 times higher than the concentration of when they are used as the polishing agent, and after both liquids thus concentrated are mixed, the resulting mixture may be diluted to give a predetermined concentration when being used as the polishing agent. More specifically, for example, when the liquids are prepared by concentrating 10 times as to all of the concentration of the cerium compound particle in the dispersion liquid α and the concentrations of the organic acid having a plurality of carboxylic acid groups or carboxylates and the nonionic compound (P), the polishing agent can be obtained by mixing 10 parts by mass of the dispersion liquid α, 10 parts by mass of the liquid additive for polishing and 80 parts by mass of water, and diluting the resulting mixture 10 times.

### <Preparation Method of Polishing Agent>

The polishing agent of the present invention is prepared using a method where the organic acid having a plurality of carboxylic acid groups or carboxylates and the nonionic compound (P) are added to and mixed with a dispersion liquid obtained by dispersing the cerium compound particle in water such as pure water or ion-exchanged water. The polishing agent may be prepared only by the above components to have a pH falling in the predetermined range above, but in the case where the pH is not in the predetermined range above, a pH regulator is further added to adjust the pH of the obtained polishing agent to fall in the predetermined range above. After the mixing, the mixture is stirred for a predetermined time by using a stirrer, etc., and a uniform polishing agent can thereby be obtained. In addition, a better dispersion state may also be realized by using an ultrasonic disperser after the mixing.

The polishing agent of the present invention needs not necessarily be supplied to the polishing site as a mixture obtained by previously mixing all of the constituent polishing components. The polishing components may be mixed to formulate the composition of the polishing agent when it is supplied to the polishing site.

For the convenience of storage or transportation of the polishing agent of the present invention, the cerium compound particle dispersion liquid (dispersion liquid α) and the liquid additive for polishing (aqueous solution β) may be separately prepared as two liquids and be mixed when being used. In the case of separately preparing the dispersion liquid a and the aqueous solution β as two liquids and mixing these liquids to prepare a polishing agent, as described above, the concentrations of the organic acid having a plurality of carboxylic acid groups or carboxylates and the nonionic compound (P) in the aqueous solution β may be set, for example, about 10 times higher than those of when being used as the polishing agent, and after mixing, the mixture may be diluted with water to a predetermined concentration and then be used.

### <Polishing Method>

The polishing method according to the embodiment of the present invention is a method of bringing the surface to be polished of a polishing target into contact with a polishing pad while supplying the above-described polishing agent to perform polishing by relative movement between those two members. Here, the surface to be polished on which polishing is performed is, for example, a semiconductor substrate surface including a surface composed of silicon dioxide. As the semiconductor substrate, a substrate for STI described above is exemplified as a preferred example. The polishing method of the present invention is also effective in polishing for flattening an interlayer insulating film between multilayer wirings in the manufacture of a semiconductor device.

The silicon dioxide film in a substrate for STI includes a so-called PE-TEOS film deposited by a plasma CVD method using tetraethoxysilane (TEOS) as a raw material. In addition, the silicon dioxide film also includes a so-called HDP film deposited by a high-density plasma CVD method. The silicon nitride film includes a film deposited by a low-pressure CVD method or plasma CVD method using silane or dichlorosilane and ammonia as raw materials.

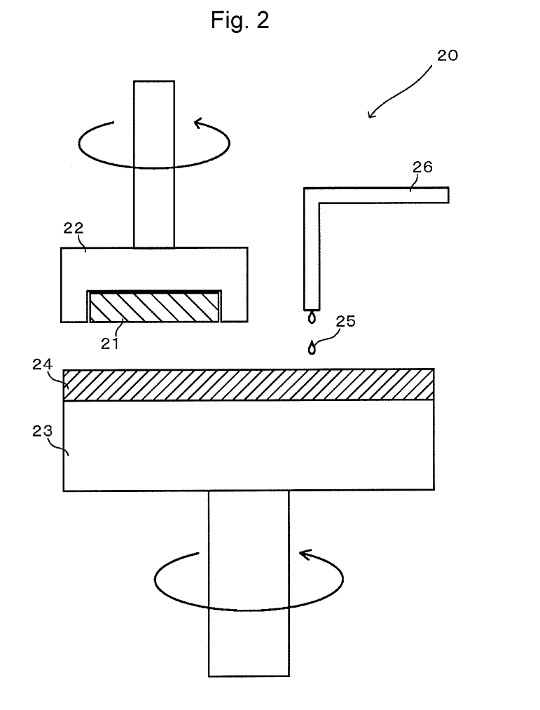

For the polishing method in the embodiment of the present invention, a known polishing apparatus can be used. FIG. 2 is a diagram illustrating one example of a polishing apparatus usable in the polishing method of the present invention.

The polishing apparatus 20 includes a polishing head 22 for holding a semiconductor substrate 21 such as STI substrate, a polishing platen 23, a polishing pad 24 attached to a surface of the polishing platen 23, and a polishing agent supply pipe 26 for supplying a polishing agent 25 to the polishing pad 24. The apparatus is configured to bring the surface to be polished of the semiconductor substrate 21 held in the polishing head 22 into contact with the polishing pad 24 while supplying the polishing agent 25 from the polishing agent supply pipe 26 and perform polishing by relative rotational movement between the polishing head 22 and the polishing platen 23. However, the polishing apparatus used in the embodiment of the present invention is not limited to those having such a structure.

The polishing head 22 may perform not only rotational movement but also linear movement. In addition, the polishing platen 23 and the polishing pad 24 may have a size equivalent to or smaller than that of the semiconductor substrate 21. In this case, the polishing head 22 and the polishing platen 23 are preferably moved relatively so that the entire surface of the surface to be polished of the semiconductor substrate 21 can be polished. Furthermore, the polishing platen 23 and the polishing pad 24 may not perform rotational movement and may move, for example, in one direction by a belt system.

The polishing conditions of the polishing apparatus 20 are not particularly limited, but the polishing head 22 is pressed against the polishing pad 24 under load so that the polishing pressure can be more increased and the polishing rate can be more enhanced. The polishing pressure is preferably about 0.5 to 50 kPa and is more preferably about 3 to 40 kPa from the viewpoint of uniformity of the polishing rate within the surface to be polished of the semiconductor substrate 21, flatness and prevention of a polishing defect such as scratch. The rotation speed of the polishing platen 23 and the polishing head 22 is preferably about 50 to 500 rpm, but the present invention is not limited thereto. The supply amount of the polishing agent 25 is appropriately adjusted according to the composition of polishing agent, the above-described polishing conditions, etc.

As the polishing pad 24, a pad made of nonwoven fabric, foamed polyurethane, porous resin, nonporous resin, etc. may be used. In order to accelerate the supply of the polishing agent 25 to the polishing pad 24 or allow a certain amount of the polishing agent 25 to stay on the polishing pad 24, the surface of the polishing pad 24 may be grooved, for example, in a grid, concentric or spiral pattern. In addition, a pad conditioner may be brought into contact with the surface of the polishing pad 24, if desired, to perform polishing while conditioning the polishing pad 24 surface.

According to the polishing method of the present invention, in a CMP treatment such as flattening of an interlayer insulating film in the manufacture of a semiconductor device or flattening of an insulating film for STI, a surface to be polished including silicon oxide (e.g., silicon dioxide) can be polished at a high polishing rate.

### EXAMPLES

The present invention is more specifically described below by referring to Examples and Comparative Examples, but the present invention is not limited to these Examples.

Examples 1 to 7 are working examples and examples 8 to 11 are comparative examples. In the following examples, unless otherwise indicated, “%” means mass %. In addition, the characteristic values were measured and evaluated by the following methods.

[pH]

The pH was measured using pH Meter HM-30R manufactured by DKK-TOA Corporation.

### [Average Secondary Particle Diameter]

The average secondary particle diameter was measured using a laser scattering/diffraction particle size distribution analyzer (device name: LA-920, manufactured by Horiba, Ltd.).

### [Polishing Characteristics]

The polishing characteristics were evaluated by performing the following polishing by means of a full automatic CMP polishing apparatus (device name: Mirra, manufactured by Applied Materials, Inc.). As the polishing pad, a two-layer polyurethane pad (Shore D value: 45) was used, and for the conditioning of polishing pad, a CVD diamond pad conditioner (trade name: Trizact B5, manufactured by 3M Company) was used. The polishing conditions were a polishing pressure of 21 kPa, a rotation speed of the polishing platen of 77 rpm, and a rotation speed of the polishing head of 73 rpm. The supply rate of the polishing agent was set to 200 ml/min.

In order to measure the polishing rate, a blanket substrate with a silicon dioxide film, in which a silicon dioxide film was deposited on an 8-inch silicon wafer by plasma CVD using tetraethoxysilane as a raw material, was used as the polishing target (material to be polished).

For the measurement of film thickness of the silicon dioxide film deposited on the blanket substrate, a thickness meter, UV-1280SE, manufactured by KLA-Tencor Corp. was used. The polishing rate for each of the silicon dioxide film and the silicon nitride film was calculated by determining the difference between the film thickness before polishing of the blanket substrate and the film thickness after polishing for 1 minute. The average value (A/min) of the polishing rate, obtained from the polishing rates at 49 points in a plane of the substrate, was used as an evaluation index of the polishing rate.

### Example 1

A cerium oxide dispersion liquid obtained by dispersing cerium oxide particles having an average secondary particle diameter of 100 nm in pure water (hereinafter, referred to as Cerium Oxide Dispersion Liquid a) was added to pure water to afford a cerium oxide particle content ratio (concentration) of 0.25% relative to the total mass of the polishing agent. Thereafter, polyacrylic acid that is an organic acid having a plurality of carboxylic acid groups or carboxylates (an organic acid including substantially only the unit of acrylic acid and having a weight average molecular weight of 7,000; in all of the following Examples, this polyacrylic acid was used as the polyacrylic acid) was added to afford a content ratio (concentration) of 0.1%, and polyoxyethylene diglyceryl ether as the polymer (21) (in formula (21), p1+q1+r1+s1≈13, weight average molecular weight: 750) (hereinafter, referred to as Nonionic Compound A; in Table 1, indicated by “polyoxyethylene diglyceryl ether (Mw 750); Mw means the weight average molecular weight) was added to afford a content ratio (concentration) of 0.01%. After stirring, the pH was adjusted to 7.5 by further adding monoethanolamine (hereinafter, referred to as MEA) to obtain Polishing Agent (1).

### Examples 2 and 3

Cerium Oxide Dispersion Liquid a, polyacrylic acid and Nonionic Compound A were added to pure water each to afford the content ratio (concentration) shown in Table 1 and after stirring, the pH was adjusted to the value shown in Table 1 by further adding a pH regulator to obtain Polishing Agents (2) and (3).

### Example 4

Cerium Oxide Dispersion Liquid a, polyacrylic acid and polyoxyethylene diglyceryl ether as the polymer (21) (in formula (21), p1+q1+r1+s14, weight average molecular weight: 350) (hereinafter, referred to as Nonionic Compound B; in Table 1, indicated by “polyoxyethylene diglyceryl ether (Mw 350); Mw means the weight average molecular weight) were added to pure water each to afford the content ratio (concentration) shown in Table 1 and after stirring, the pH was adjusted to the value shown in Table 1 by further adding a pH regulator to obtain Polishing Agent (4).

### Example 5

A cerium oxide dispersion liquid obtained by dispersing cerium oxide particles having an average secondary particle diameter of 170 nm in pure water (hereinafter, referred to as Cerium Oxide Dispersion Liquid b) was added to pure water to afford a cerium oxide particle content ratio (concentration) of 0.5% relative to the total mass of the polishing agent. Thereafter, polyacrylic acid that is an organic acid having a plurality of carboxylic acid groups or carboxylates, and polyoxyethylene diglyceryl ether as the polymer (21) (in formula (21), p1+q1+r1+s120, weight average molecular weight: 1,000) (hereinafter, referred to as Nonionic Compound C; in Table 1, indicated by “polyoxyethylene diglyceryl ether (Mw 1000); Mw means the weight average molecular weight) were added to pure water each to afford the content ratio (concentration) shown in Table 1 and after stirring, the pH was adjusted to the value shown in Table 1 by further adding a pH regulator to obtain Polishing Agent (5).

### Example 6

A cerium oxide dispersion liquid obtained by dispersing cerium oxide particles having an average secondary particle diameter of 170 nm in pure water (hereinafter, referred to as Cerium Oxide Dispersion Liquid b) was added to pure water to afford a cerium oxide particle content ratio (concentration) of 0.50% relative to the total mass of the polishing agent. Thereafter, polyacrylic acid that is an organic acid having a plurality of carboxylic acid groups or carboxylates, and polyoxyethylene diglyceryl ether as the polymer (21) (in formula (21), p1+q1+r1+s160, weight average molecular weight: 3,000) (hereinafter, referred to as Nonionic Compound D; in Table 1, indicated by “polyoxyethylene diglyceryl ether (Mw 3,000); Mw means the weight average molecular weight) were added to pure water each to afford the content ratio (concentration) shown in Table 1 and after stirring, the pH was adjusted to the value shown in Table 1 by further adding a pH regulator to obtain Polishing Agent (6).

### Example 7

Cerium Oxide Dispersion Liquid b, polyacrylic acid and Nonionic Compound C were added to pure water each to afford the content ratio (concentration) shown in Table 1 and after stirring, the pH was adjusted to the value shown in Table 1 by further adding a pH regulator to obtain Polishing Agent (7).

### Example 8

Cerium Oxide Dispersion Liquid a and polyacrylic acid were added to pure water each to afford the content ratio (concentration) shown in Table 1 and after stirring, the pH was adjusted to the value shown in Table 1 by further adding a pH regulator to obtain Polishing Agent (8).

### Example 9

Cerium Oxide Dispersion Liquid b and polyacrylic acid were added to pure water each to afford the content ratio (concentration) shown in Table 1 and after stirring, the pH was adjusted to the value shown in Table 1 by further adding a pH regulator to obtain Polishing Agent (9).

### Example 10

Cerium Oxide Dispersion Liquid b, polyacrylic acid and Nonionic Compound A were added to pure water each to afford the content ratio (concentration) shown in Table 1 and after stirring, the pH was adjusted to the value shown in Table 1 by further adding a pH regulator to obtain Polishing Agent (10).

### Example 11

Cerium Oxide Dispersion Liquid b, polyacrylic acid and Nonionic Compound C were added to pure water each to afford the content ratio (concentration) shown in Table 1 and after stirring, the pH was adjusted to the value shown in Table 1 by further adding a pH regulator to obtain Polishing Agent (11).

The polishing characteristics (polishing rate for a silicon dioxide film) of each of Polishing Agents (1) to (11) obtained in Examples 1 to 11 were measured by the method described above. The measurement results are shown in Table 1.

TABLE 1

| | Average Secondary | | | | |
|---|---|---|---|---|---|
| | Particle Diameter | Cerium Oxide | | Organic Acid | |
| | of Cerium Oxide | Concentration | Kind of Organic | Concentration | |
| | [nm] | [mass %] | Acid | [mass %] | Kind of Nonionic Compound |
| Example 1 | 100 | 0.25 | polyacrylic acid | 0.1 | polyoxyethylene diglyceryl ether (Mw 750) |
| Example 2 | 100 | 0.25 | polyacrylic acid | 0.05 | polyoxyethylene diglyceryl ether (Mw 750) |
| Example 3 | 100 | 0.25 | polyacrylic acid | 0.01 | polyoxyethylene diglyceryl ether (Mw 750) |
| Example 4 | 100 | 0.25 | polyacrylic acid | 0.1 | polyoxyethylene diglyceryl ether (Mw 350) |
| Example 5 | 170 | 0.5 | polyacrylic acid | 0.05 | polyoxyethylene diglyceryl ether (Mw 1000) |
| Example 6 | 170 | 0.5 | polyacrylic acid | 0.05 | polyoxyethylene diglyceryl ether (Mw 3000) |
| Example 7 | 170 | 0.25 | polyacrylic acid | 0.30 | polyoxyethylene diglyceryl ether (Mw 1000) |
| Example 8 | 100 | 0.25 | polyacrylic acid | 0.1 | — |
| Example 9 | 170 | 0.5 | polyacrylic acid | 0.05 | — |
| Example 10 | 170 | 0.5 | polyacrylic acid | 0.05 | polyoxyethylene diglyceryl ether (Mw 750) |
| Example 11 | 170 | 0.5 | polyacrylic acid | 0.05 | polyoxyethylene diglyceryl ether (Mw 1000) |

| | Nonionic Compound | | |
|---|---|---|---|
| | Concentration | | Silicon Oxide Polishing |
| | [mass %] | pH | Rate [Å/min] |
| Example 1 | 0.01 | 7.5 | 1995 |
| Example 2 | 0.01 | 6.0 | 2374 |
| Example 3 | 0.01 | 6.0 | 2093 |
| Example 4 | 0.2 | 6.0 | 1828 |
| Example 5 | 0.01 | 5.5 | 1902 |
| Example 6 | 0.01 | 5.5 | 1837 |
| Example 7 | 0.01 | 7.2 | 3692 |
| Example 8 | — | 6.0 | 1478 |
| Example 9 | — | 5.5 | 1519 |
| Example 10 | 0.01 | 3.5 | cannot be evaluated due to aggregation |
| Example 11 | 0.01 | 9.5 | cannot be evaluated due to aggregation |

Table 1 reveals the followings. That is, when polishing was performed using Polishing Agents (1) to (7) of Examples 1 to 7 containing a cerium oxide particle as the cerium compound particle, an organic acid having a plurality of carboxylic acid groups or carboxylates, a nonionic compound (P), and water, and having a pH of 4 to 9, a high polishing rate for a carbon dioxide film was obtained.

On the other hand, it is seen that when Polishing Agents (8) and (9) of Examples 8 and 9 containing absolutely no nonionic compound (P) were used, the polishing rate for a carbon dioxide film was greatly reduced, compared with Examples 1 to 7. In addition, when Polishing Agent (10) of Example 10 having a pH adjusted to 3.5 and Polishing Agent (11) of Example 11 having a pH adjusted to 9.5 were used, aggregation occurred and therefore, the polishing rate could not be evaluated.

### INDUSTRIAL APPLICABILITY

According to the present invention, for example, in CMP of a surface to be polished including a surface composed of silicon oxide, a sufficiently high polishing rate for a silicon oxide film can be achieved. Therefore, the polishing agent and polishing method of the present invention are suitable for flattening of an insulating film for STI in the manufacture of a semiconductor device.

This application is based on Japanese Patent Application No. 2018-037456 filed on Mar. 2, 2018, the contents of which are incorporated herein by way of reference.

### DESCRIPTION OF REFERENCE NUMERALS AND SIGNS

1: Silicon substrate, 2: Silicon nitride film, 3: Trench, 4: Silicon dioxide film, 20: Polishing apparatus, 21: Semiconductor substrate, 22: Polishing head, 23: Polishing platen, 24: Polishing pad, 25: Polishing agent, 26: Polishing agent supply pipe

1. A polishing agent, comprising:
particles of a compound comprising a cerium atom and an oxygen atom;
an organic acid having a plurality of carboxylic acid groups or carboxylates;
at least one selected from the group consisting of a polyhydric alcohol and an addition polymerization product of a polyhydric alcohol with an alkylene oxide; and
water,
wherein the polishing agent has a pH of 4 to 9.

2. The polishing agent according to claim 1, wherein:
the polyhydric alcohol comprises polyglycerin; and
the addition polymerization product of the polyhydric alcohol with an alkylene oxide comprises a polyoxyalkylene polyglyceryl ether, provided that the alkylene is at least one selected from the group consisting of ethylene and propylene.

3. The polishing agent according to claim 1,
wherein an average secondary particle diameter of the particles of the compound is from 10 nm to 500 nm.

4. The polishing agent according to claim 1, wherein an average secondary particle diameter of the particles of the compound is from 10 nm to 170 nm.

5. The polishing agent according to claim 1, wherein the particles of the compound is a cerium oxide particle.

6. The polishing agent according to claim 1, wherein the organic acid is at least one selected from the group consisting of a polymer of an unsaturated carboxylic acid, a copolymer of an unsaturated carboxylic acid and a monomer containing no carboxylic acid group, a partially esterified product of the polymer or copolymer, and salts thereof.

7. The polishing agent according to claim 1, wherein the organic acid is at least one selected from the group consisting of a polymer of an acrylic acid, a copolymer of an acrylic acid and a monomer other than an acrylic acid, a partially esterified product of the polymer or copolymer, and salts thereof.

8. The polishing agent according to claim 1, wherein the organic acid is at least one selected from the group consisting of
a polymer containing at least one selected from the group consisting of maleic acid and fumaric acid,
a copolymer of at least one selected from the group consisting of maleic acid and fumaric acid and a monomer which is neither maleic acid nor fumaric acid,
a partially esterified product of the polymer or the copolymer, and
salts thereof.

9. The polishing agent according to claim 1, wherein a content ratio of the organic acid is from 0.001 to 2.0 mass % relative to a total mass of the polishing agent.

10. The polishing agent according to claim 1, wherein a content ratio of the at least one selected from the group consisting of the polyhydric alcohol and the addition polymerization product of a polyhydric alcohol with an alkylene oxide is from 0.001 to 2.0 mass % relative to a total mass of the polishing agent.

11. The polishing agent according to claim 1, wherein a content ratio of the particle of the compound containing a cerium atom and an oxygen atom is from 0.01 to 10.0 mass % relative to a total mass of the polishing agent.

12. A polishing method, comprising contacting a polishing pad with a surface to be polished while supplying a polishing agent to perform polishing by relative movement thereof,
wherein the surface to be polished includes a surface comprising silicon oxide of a semiconductor substrate is polished with the polishing agent of claim 1 as the polishing agent.

13. A liquid additive for polishing, which is a liquid additive for preparing a polishing agent by mixing with a dispersion liquid of particles of a compound containing a cerium atom and an oxygen atom, the liquid additive comprising:
an organic acid having a plurality of carboxylic acid groups or carboxylates;
at least one selected from the group consisting of a polyhydric alcohol and an addition polymerization product of a polyhydric alcohol with an alkylene oxide; and
water, and
wherein the polishing agent has a pH of 4 to 9.

14. The liquid additive for polishing according to claim 13, wherein the organic acid having a plurality of carboxylic acid groups or carboxylates is at least one selected from the group consisting of a polymer of an unsaturated carboxylic acid, a copolymer of an unsaturated carboxylic acid and a monomer containing no carboxylic acid group, a partially esterified product of the polymer or the copolymer, and salts thereof.
